(19) United States
(12) Patent Application Publication
(10) Pub. No.: US 2002/0065818 A1
(43) Pub. Date: May 30, 2002

(54) Computerized method and applications generator system for developing a customizable electronic records management system

(76) Inventor: Ronald E. Starr, Altamonte Springs, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 09/934,441

(22) Filed: Aug. 21, 2001

Related U.S. Application Data
(60) Provisional application No. 60/227,423, filed on Aug. 23, 2000.

(51) Int. Cl. G06F 7/00

(52) U.S. Cl. 707/5

(57) ABSTRACT

Computerized method and applications generator system for developing an electronic records management system customizable to meet the ongoing information needs of users of a given enterprise application, e.g., a business application, governmental, educational, or any other application that requires accurate and reliable management of relatively large amounts of information are provided. The method allows to provide a plurality of control tables configurable by an expert in the enterprise application, with a first set of the control tables being configurable to define system-level operational functions, with a second set of the control tables being configurable to define a selected input medium for uploading information into a repository database, and with a third set of the control tables being configurable to define a selected output medium for downloading information from the database. An input/output device is provided for accessing the plurality of control tables. The method further allows to populate each control table with prescribed rules provided by the expert through the input/output device for invoking a respective action in response to a user-triggered event. The control tables are processed to construct a respective record set object array corresponding to the rules provided by the expert to build in response to each constructed record set object array a customized records management system, with the system being accessible by the users through the selected input and output mediums in accordance with the prescribed rules provided by the expert.

The present application claims the benefit of U.S. patent application Ser. No. 60/277,432, filed on Aug. 23, 2000.

A portion of the disclosure of this patent document includes material which is subject to copyright protection. The copyright owner has no objection to the facsimile reproduction by anyone of the patent document or the patent disclosure, as it appears in the Patent and Trademark Office Patent File or records, but otherwise reserves all copyrights whatsoever.

### BACKGROUND OF THE INVENTION

The present invention is generally related to computer-based system and techniques for developing and configuring electronic record applications, and, more particularly, to a Dynamic Application Generator (DAG) system including a Repository of Application Knowledge (RAK) tables that enable user-created personalization and customization features in a Rapid Application Development Environment (RADE).

Known computer-based record systems are generally designed as “one-size-fits-all” systems, i.e., the user has to burdensomely adapt his or her records to fit the computer based record system. While such systems have somewhat alleviated the needs of some users, most users would prefer to have a personalized and customized record system that manages data accessible by a wide variety of users in a form that is more appropriate to their needs. Users also would prefer systems that can be used and interact in ways comfortable to the user and can interface with other desktop applications.

Accordingly, it would be desirable to provide a computer-based DAG system having a graphical user interface (GUI) built on an industry standard platform that is web-enabled; to provide for common access techniques across a variety of platforms that potentially could be globally based; and to provide system and techniques that enable the users to be actively engaged in the development of their business solutions without having to create a costly Information Technology (I/T) department. It would be further desirable to provide system and techniques unconstrained from application-specific intelligence. That is, system and techniques that dynamically generate any business application that is specified in a set of RAK tables. For example, these tables may be resident in a relational database to be quickly and cost-effectively populated by business Subject Matter Experts (SMEs)—not programmers.

### BRIEF SUMMARY OF THE INVENTION

Generally, the present invention fulfills the foregoing needs by providing in one aspect thereof a computerized method for developing an electronic records management system customizable to meet the ongoing information needs of users of a given enterprise application, e.g., a business application, governmental, educational, or any other application that requires accurate and reliable management of relatively large amounts of information. The method allows for providing a plurality of control tables configurable by an expert in the enterprise application, with a first set of the control tables being configurable to define system-level operational functions, with a second set of the control tables being configurable to define a selected input medium for uploading information into a repository database, and with a third set of the control tables being configurable to define a selected output medium for downloading information from the database. An input/output device is provided for accessing the plurality of control tables. The method further allows populating each control table with prescribed rules provided by the expert through the input/output device for invoking a respective action in response to a user-triggered event. The control tables are processed to construct a respective record set object array corresponding to the rules provided by the expert to build in response to each constructed record set object array a customized records management system, with the system being accessible by the users through the selected input and output mediums in accordance with the prescribed rules provided by the expert.

The present invention further fulfills the foregoing needs by providing in another aspect thereof, a computerized applications generator system for developing an electronic records management system customizable to meet the ongoing information needs of users of a given enterprise application. The applications generator system includes memory for storing a plurality of control tables configurable by an expert in the enterprise application, with a first set of the control tables being configurable to define system-level operational functions, with a second set of the control tables being configurable to define a selected input medium for uploading information into a repository database, and with a third set of the control tables being configurable to define a selected output medium for downloading information from the database. An input/output device is provided for accessing the plurality of control tables and populating each control table with prescribed rules provided by the expert for invoking a respective action in response to a user-triggered event. A processor is configured to process the control tables and construct a respective record set object array corresponding to the rules provided by the expert to build in response to each constructed record set object array a customized records management system, with the system being accessible by the users through the selected input and output mediums in accordance with the prescribed rules provided by the expert.

### BRIEF DESCRIPTION OF THE DRAWINGS

The features and advantages of the present invention will become apparent from the following detailed description of the invention when read with the accompanying drawings in which:

FIG. 1 illustrates a schematic diagram representation of an exemplary communications network that may be used for interconnecting with a Dynamic Application Generator (DAG) system embodying aspects of the present invention.

FIGS. 2-4 respectively illustrate exemplary graphical user interfaces in the form of Web pages that may be used for communicating with the DAG system.

FIG. 5 illustrates in block diagram form exemplary modules and operational interrelationships among such modules, including Visual programs, controls, tools and control tables that make up the DAG system in accordance with aspects of the invention.

FIGS. 6 and 7 respectively illustrate Web pages used by a SME for configuring an exemplary control table, e.g., the SME has chosen to change the KeyPad_Control RAK control table

FIGS. 8 and 9 respectively illustrate flow charts of exemplary actions for processing a menu control table in accordance with prescribed rules FIGS. 15 and 16 illustrates respective flow charts of exemplary actions for processing a search control table, such as may be used for retrieving data from the repository database using a selected key.

FIGS. 10 and 11 respectively illustrate flow charts of exemplary actions for processing a tree control table.

FIG. 12 illustrates a flow chart of exemplary actions for processing a form control table, such as may be used uploading or downloading data from a repository database.

FIG. 13 illustrates a flow chart of exemplary actions for processing data gathering vehicles or mediums, e.g., a dropdown, a key pad, data trees, such as may be used in a form for uploading or downloading information from the repository database.

FIG. 14 illustrates a flow chart of exemplary actions for processing a message control table, such as may be used for conveying messages temporarily displayed to users.

FIGS. 15 and 16 illustrates respective flow charts of exemplary actions for processing a search control table, such as may be used for retrieving data from the repository database using a selected key.

FIGS. 17 and 18 illustrates respective flow charts of exemplary actions for processing a voice control table, such as may be used FIGS. 15 and 16 for navigating and commanding the system in response to predefined user-voice utterances.

FIG. 19 illustrates exemplary details regarding the computerized applications generator system of FIG. 1 for developing an electronic records management system customizable to meet the ongoing information needs of users of a given enterprise application.

### DETAILED DESCRIPTION OF THE INVENTION

Dynamic Application Generator (Dag) System Overview

The system and techniques of the present invention are designed and constructed to overcome the traditional problems encountered by user organizations in developing, maintaining and using business application software. Traditionally, these users tend to become dissatisfied due to the lengthy and expensive timelines they must endure to have their business needs met by either their in-house I/T staff or outsourced I/T services. Moreover, their systems never seem to completely meet their ever-changing needs. To compound the problems, they must live with the extreme frustrations over the same issues when they request changes be made.

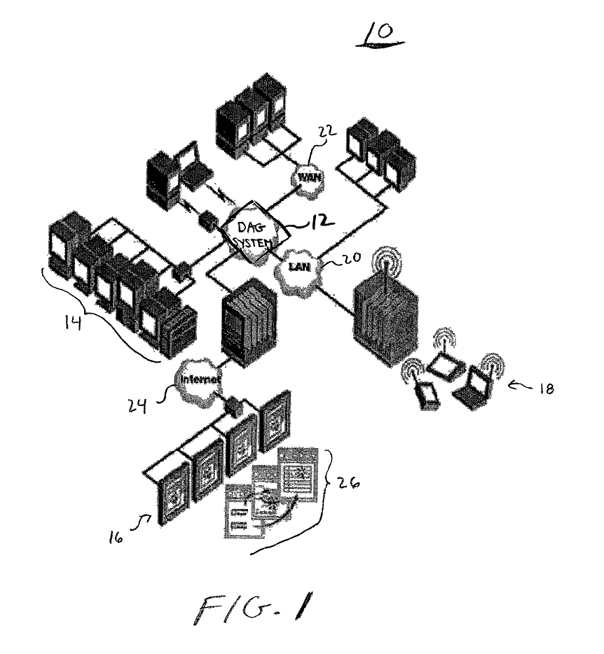

FIG. 1 illustrates a schematic diagram representation of an exemplary information network 10 that may benefit from a Dynamic Application Generator (DAG) system 12 in accordance with aspects of the present invention. As shown in FIG. 1, system 12 may be remotely accessed by any of a plurality of user terminals, such as desktop terminals 14, Web appliances 16, wireless Personal Digital Assistants (PDAs) 18, etc. As will be appreciated by those skilled in the art, communication between system 12 and the user terminals may be implemented via any suitable network, such as Local Area Network 20, a Wide Area Network 22, the Internet, an intranet, etc. In one exemplary embodiment, the user terminals may include a commercially available Internet browser, such as Microsoft Internet Explorer browser, for downloading/uploading information in the form of Web pages 24. In one aspect thereof, the system 12 provides a user-friendly visual development environment composed of sophisticated programs that are unconstrained by application-specific knowledge.

As suggested above, the system 12 automatically and dynamically generates enterprise applications, e.g., business, governmental, educational, or any other application that generally requires accurate and reliable management of relatively large amounts of information. The generated application is capable of capturing, updating, storing, and bilaterally replicating data across normal application barriers. DAG system 12 accomplishes this by following prescribed rules, such as linguistics instructions (e.g., English, Spanish, etc.) provided by the SMEs (Subject Matter Experts. That is, an expert in the enterprise application) through a straight-forward person-machine dialogue in which the application specifications are stored as data in a set of tables referred to as the Repository of Application Knowledge (RAK) tables. This ensures that the functionality of the business application is able of being specified, developed, and modified by an analyst who is a business Subject Matter Expert (SME), not through programming code by an expensive programmer. This technique ensures that what traditionally has been an extremely time consuming and expensive Information Technology (I/T) process to build and maintain information systems—can now become a user driven and controlled process. The DAG system is constructed using an industry standard visual-software-platform that provides common access across a wide variety of computerized platforms geographically dispersed potentially worldwide. By way of example, these platforms may be compatible with any of various operating systems, such as Windows 95, 98, NT, Windows 2000, CE, or Pocket PC based platforms. Further, the system 12 is also network independent. That is, the system is fully functional regardless of any specific network technology, e.g., wired, wireless, Internet, Intranet, ASP, WASP, etc.

Process Overview

One exemplary process to utilize the Dynamic Application Generator (DAG) system is as follows:

One or more Subject Matter Experts (SMEs) for a particular business application would define the requirements for the application, e.g. data to be gathered, GUI to be used as gathering vehicle, editing requirements, menus, trees, drop downs, etc., input/output device (PC, PDA, Telephone, Wireless Or Wired Device, etc.), data repository requirements, etc. The SME then populates the Repository of Application Knowledge (RAK) tables with this information. The SME then runs the DAG system and, in turn, the system processes, e.g., reads and interprets or decodes, the RAK tables and builds the application “on-the-fly”. The SME can then modify the RAK table entries as required to test the application, re-run the DAG system, and complete testing of the application. The application would now be ready for a production load on any appropriate user device(s), such as a server accessible to the users. For example, this would entail installing the DAG system and the SME built RAK tables on the server. Each time a user invokes their application, the DAG system would rebuild the application ‘on-the-fly’, thus ensuring that as the SME makes modifications to the application by updating the RAK tables, each user will have the latest application version.

The advantageous benefits of this invention may be better appreciated through the various application examples, provided in Appendix 1 to this specification. In one example for a pharmaceutical application, SMEs presented with a multipage clinical trial screening package from a pharmaceutical client, using the DAG system in accordance with aspects of the present invention, developed a production ready clinical trial data acquisition application in less than one person day by populating a set of Repository of Application Knowledge (RAK) tables. Using a more traditional application development and programming approach would have likely consumed a minimum of 35 person days. This application was built for a large outpatient clinic that required access via the web. The application has at least two types of users, (e.g., physicians and administrative assistants) and each was required to receive their unique menu and tree choices to provide the respective functionality they could invoke.

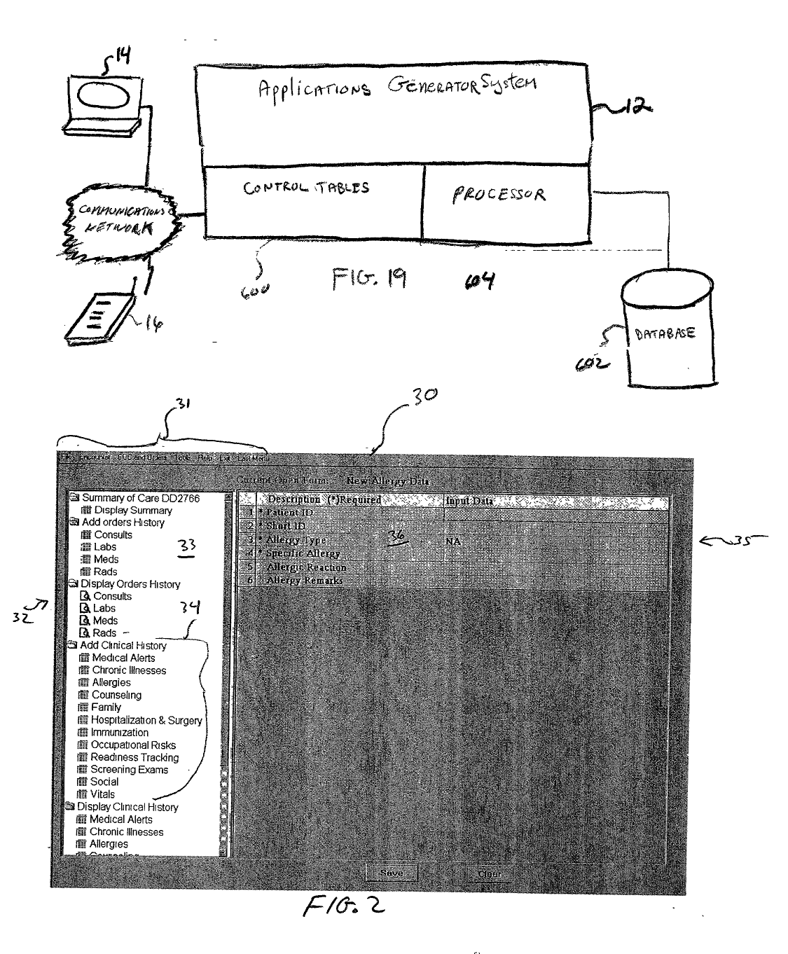

A physician user who is entering or reviewing clinical data about a patient may use a graphical user interface (GUI), such as a Web page 30, illustrated in FIG. 2. The DAG system dynamically built each segment of the GUI in FIG. 2 from the RAK tables populated by the clinical SME. A menu 31 is at the top section of Web page 30 with suitable label and identifying data. A first window 32 includes a Menu Tree 33 with a plurality of nodes, e.g., nodes 34, that allow the user to either, add, edit or display clinical history data. A second window 35 illustrates a form 36 used to add a new allergy for a selected patient. Various data fields in form 36, e.g., Patient ID, Short ID, Allergy Type and Specific Allergy are marked with an asterisk, meaning such data fields are required to be completed and the form may not be saved until entries in each of such data fields is made.

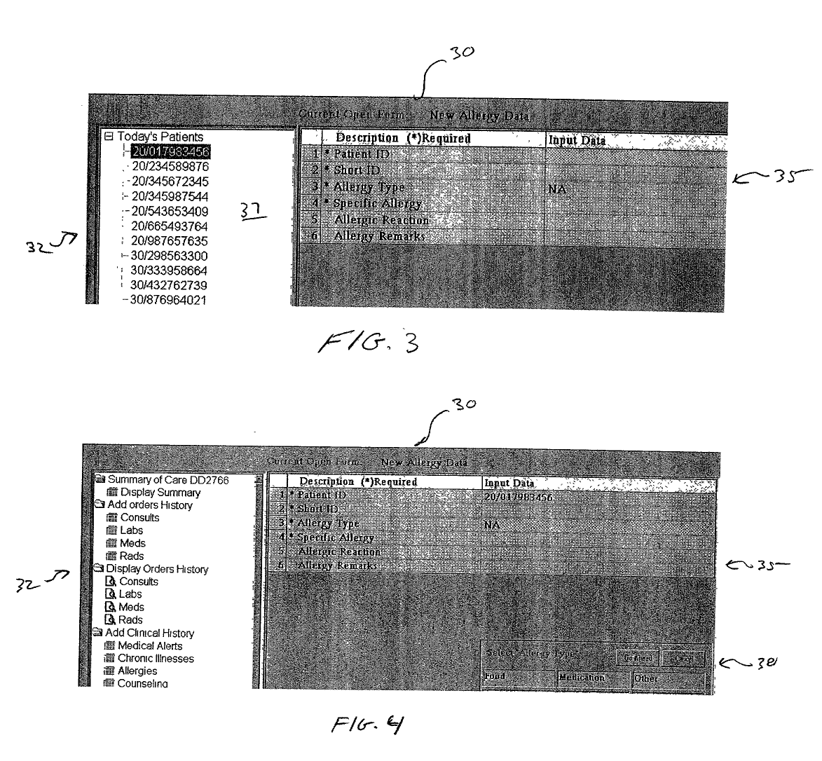

As illustrated in Web page 30 in FIG. 3, when a user clicks on Patient_ID, the SME has determined that a given patient identified by a suitable identifier should be chosen from a patient data tree 37 and has constructed an appropriate Tree_Control RAK table to handle the situation. The data tree 37 will be displayed on the first window 32 as configured in a Data Tree control object of the system. An appropriate menu selection can be made by a suitable computer interface activity, e.g., keyboard, double click or drag and drop anywhere in the second window 35. The menu 31 (FIG. 2) was also built by the SME and includes those menu actions he or she has determined should be included within the application and invoked from a dynamically generated menu.

As illustrated in Web page 30 in FIG. 4, when a user clicks on Allergy Type, the SME has determined that a given type of allergy should be chosen from a keypad 38 and has populated a KeyPad_Control RAK table to accommodate this situation. The keypad will be displayed in the window 35 using a keypad control object in the system. For example, a selection can be made by keyboard or double click.

The techniques of the present invention, in one aspect therefore, built around the creation of appropriately configured RAK tables, ensure that:

Enterprises regardless of site and geographical location can exceed their demands for increased speed and reduced cost both in the initial development, and modification of their critical business applications, and users, who are demanding systems that can be quickly and easily personalized for them, can have their expectations not only met, but also surpassed.

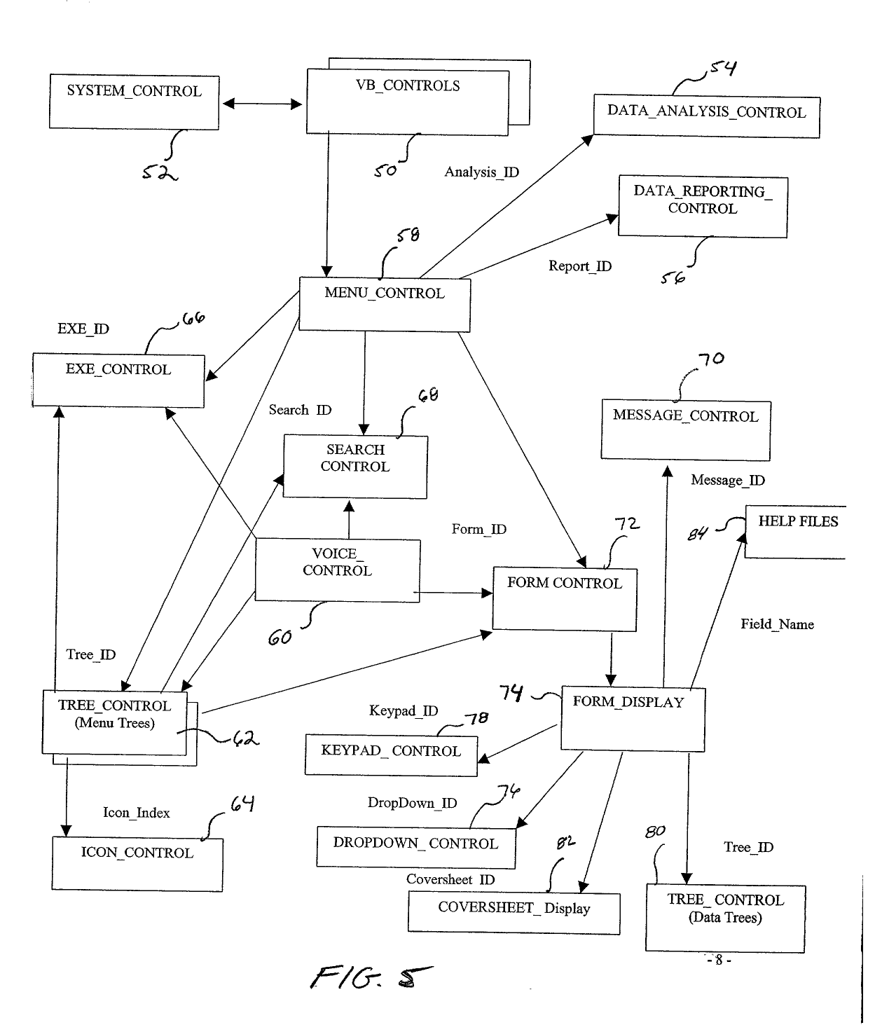

FIG. 5 illustrates in block diagram form exemplary modules and operational interrelationships among such modules, including Visual programs, controls, tools and RAK tables, that make up the DAG system in accordance with aspects of the invention. Once again, the present system provides a business application development environment in which the users of the application being developed are engaged in all phases of the development, and in which they—not programmers, control the development. The block diagram illustrated in FIG. 5 shows a top-level interaction that the DAG system utilizes in interpreting or decoding the (RAK) tables for dynamically building and executing the required business functions. Further details about the structure of the RAK tables and the associated system objects are provided below in other sections of this specification.

Top Level Description Of Repository Of Application Knowledge (Rak) Tables

The following description provides details regarding the Repository of Application Knowledge (RAK) tables, their function and interaction for running the DAG system. In one exemplary embodiment, the following RAK tables provide entry-point-control for the business application user. As such, they constitute the primary repositories to ensure that when a user chooses to invoke an action (whether by mouse, keyboard, voice, or any other computer interface activity); the system correctly interprets that choice and executes the proper sequence of process objects. Block 50 represents one or more tables for VB_CONTROL. These RAK tables comprise the Visual Basic (VB) control tables that control the internal assignments of VB controls, as well as the appropriate values to VB controls on forms within a given application. Block 52 represents a table for System_Control. This RAK table provides control for system level data about the application repository databases, type of application (e.g., voice activated or not), as well as aesthetic data, e.g. colors, font to be used, etc.

Block 54 represents a table for Data_Analysis_Control—This RAK table provides control for application data to specify additional functions to be performed on a given application data, such as a tickler function to automatically notify a user of a situation occurring in their data, e.g. a date or time in a specific field in a specific table in order to meet user-established parameters. This RAK table is also used in situations where a user specifies data processing functions, such as the processing of selected parameters to determine any trends in a given table. Block 56 represents a table for Data_Reporting_Control—This RAK table provides control to a reporting wizard that allows a user to quickly specify what they wish to see on a report. For example, show me all patients who are allergic to food where the food is tomato. Block 58 represents a table for Menu_Control—This RAK table provides control to the dynamic generation of the business application main menu and sub-menus, as well as to the processing of the appropriate action to be invoked if a menu choice is made by a computer interface activity, e.g., mouse or predefined keyboard hot keys. Block 60 represents a table for Voice_Control—This RAK table controls which action is invoked when a triggering voice utterance is received by the DAG system. This is accomplished essentially by the same techniques used for all other user-triggered actions. Depending on the specific application, the DAG system may be configured to continually monitor every voice utterance and response to those utterances that the SME analyst has specified as triggers for actions.

Block 62 represents one or more tables for Tree_Control (Menu Trees)—These RAK tables are used to provide control both to the dynamic generation of the business application menu trees, as well as to control the processing of the action to be invoked if a tree choice is made by a respective computer interface activity, e.g., mouse, including drag and drop, or keyboard activity. This allows a tree to be used in essentially the same manner as a menu. Another purpose is to dynamically generate data entry selection trees for every field in an application database for which only certain values are valid and for which the SME analyst has determined that a tree of valid choices for data entry selection is the best vehicle for having a user indicate their entry choice.

Depending on the specific application, the DAG system may be configured to continually monitor every computer interface activity, e.g., mouse double-click action as well as every drag-and-drop action and respond to those activities that the SME analyst has specified as triggers for actions. Block 64 represents a table for Icon_Control—This RAK table specifies the icons a SME designates as being required for tree nodes. Block 66 represents a table for EXE_Control—This RAK table contains data required to invoke another executable program accessible by a user, e.g., via a program name, path, etc. It is accessed when a menu choice or tree node specifies that an external program be invoked. Block 68 represents a table for Search_Control—This RAK table is referenced when a user wishes to open any entity that is a key to a repository database, e.g. patient, subject, client, employee, etc. The DAG system accesses the Search_Control and dynamically builds a search form that allows a user to specify search criteria, process the request, review results of the search and indicate which entity to open. The system then gathers all repository data related to the specified entity, and only allows actions to input new data, edit old data or display data to be accomplished for the open entity. Block 70 represents a table for Message_Control—This RAK table provides control whenever an application requires a relatively lengthy error message text box to be temporarily displayed to a user. For short edit error messages, the SME analyst would typically specify a timer message to be displayed in a column in the Form_Display RAK. In one exemplary embodiment, each message, regardless of its length may be configured as a timer display. This is a technique that uses an application specified message time period in which to display a message before it is dropped from the user screen. These messages generally do not require any user intervention to continue and consequently save user time and avoid the aggravation of having to continually click-on or somehow choose to acknowledge the message.

Application Forms Overview

One primary input medium for users of any application built with the DAG system comprises Dynamically Generated Forms (DGFs). Each DGF, regardless of its type (data grid, data combo, etc.) is generally composed of several distinct parts: Form attributes, e.g. Form Name, Form Label, repository database name, table name, etc. This kind of information is stored in a RAK table named Form_Control, as represented by block 72 in FIG. 5. The Form to be displayed and all of its controlling attributes by input field name, e.g., size, format, whether required, where to store or access the data, label name, size, special editing, error message, quick tip, actions to take, etc. This information is included in the RAK table named Form_Display, as represented by block 74 in FIG. 5.

The following tables interact to control each Dynamically Generated Form (DGF) to be displayed in an application. A common link between each table is a column Form_ID and the fact that any form will have an identical Form_ID name present in each controlling RAK table. As suggested above, the Form_Control table 72 is used by the DAG system whenever any form, grid, dialogue box, text box, etc., needs to be dynamically built and displayed to a user for data entry or review. This RAK table includes all form level control information. The Form-Display table 74 is populated by a SME analyst in order to control the building of dynamically generated display forms and grids for all data entry or data update in a given business application. Among other functions, this RAK table processes the accessing of multiple business application RAK tables and fields for automatically extracting fields to display for adding or updating purposes. By way of example, this RAK table automatically controls the following functions:

Creation of drop-downs, data input trees or keypads when required by accessing the correct data input control table.

Insertion of new rows or updated rows in the application database if required to satisfy a user request.

Editing of fields as specified in the RAK table. Creation of field labels, form headings, field quick tips, edit error messages, etc.

The DropDown_Control table 76 includes drop down combo box lists for every field in an application database for which only certain values are valid and for which the SME analyst has determined that a drop down list is the best medium for having a user indicate their entry choice. By way of example, this RAK table automatically controls the following functions:

Ensure that only valid values are entered into appropriate fields.

Build ‘Drop Down’ lists from the correct Field_Name when a user attempts to input or change data in that field. These drop down lists use appropriate linguistic descriptions of the value sets.

Store a value set code in the application database rather than the complete description a user sees, e.g. Allergy of ‘MED’ rather than ‘Medications’, Clinic type of ‘ER’ rather than ‘Emergency Medicine’. This is done to save input keystrokes and to save massive amounts of storage space.

In one exemplary embodiment, RAK table 76 is used as follows:

1. If a field is defined as being populated from a drop down list, the DAG system uses this RAK table to dynamically build a ‘Drop down’ list from which a user can choose. This drop down list is included in the DropDown_Control RAK table.

2. When a choice is made, the system uses this RAK table to retrieve the ‘Code’ that will actually be stored in the database.

3. Anytime the SME analyst has specified that this field be displayed, the system would not show the code, but would display the full description.

The KeyPad_Control table 78 includes value sets for every field in an application database for which only certain values are valid and for which the SME analyst has determined that a keypad of valid choices for a field is the best vehicle for having a user indicate their entry choice. The Tree_Control (Data Trees) table 80 is used to dynamically generate data entry selection trees for every field in an application database for which only certain values are valid and for which the SME analyst has determined that a tree of valid choices for data entry selection is the best medium for having a user indicate their entry choice. The Coversheet_Control table 82 is used to dynamically generate summary display forms when the SME analyst has determined that there is a requirement to expose data from multiple tables within a repository database on a single form. The Help Files control table 84 allows the SME analyst to create help files that are displayed whenever a user touches or ‘clicks on’ a label on a data entry form.

As will be appreciated by those skilled in the art, the DAG system through its above-described RAK tables is conducive to fast and value-added engagement of appropriate SMEs in an organization during the actual development of their information systems while diminishing or eliminating the bottlenecks associated with trying to engage a standard PIT organization.

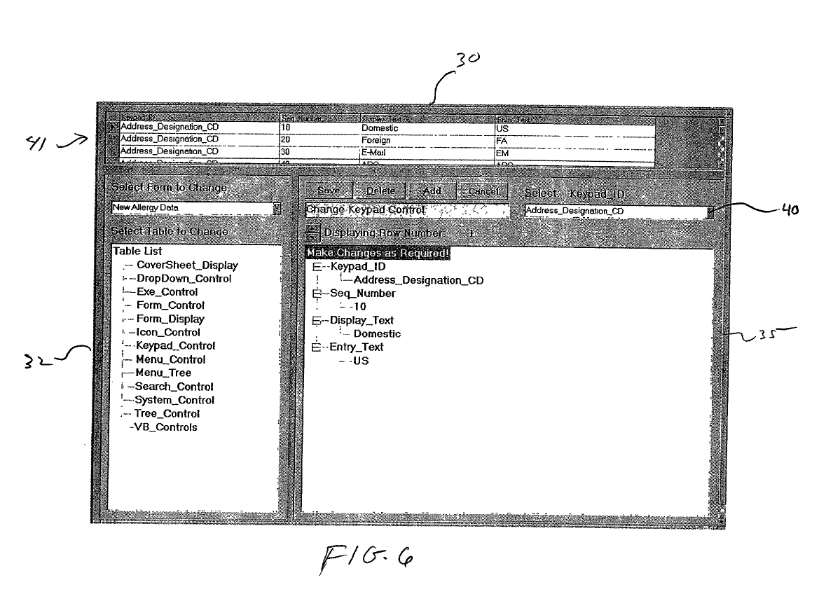

FIGS. 6 and 7 represent respective exemplary Web pages 30 that comprise one primary interface to the DAG system. They allow populating and configuring the Repository of Application Knowledge (RAK) tables and are used by the SME to either dynamically build or modify the data in these tables. That is, the data that in turn drives the DAG system to create a business application with essentially no programming. As suggested above, as each new component is added or modified by an SME he or she can invoke the DAG system and witness the result of their undertaking. This allows an SME to troubleshoot and experiment as they develop a given application; quickly catching any mistakes they might make and take corrective action. A graphical user interface (GUI), such as made up of exemplary Web pages 30, allows an SME to:

Select RAK tables to change.

Select forms to change if applicable

Select a row in a table to change

Select columns in a row to change

Modify entered data

Add new choices for data

Add or modify system Control objects to be used.

Rearrange displayed forms, trees, menus, fields, keypads, etc

Specify new or changed codes to be stored in an application database

Add new trees, menus, dropdowns, keypads, forms, etc.

Rearrange which users get which functions and features,

Add new features as dictated by the needs of the business, etc.

The choices for how to build and configure an application are limited only by the imagination of the SME and the needs of the business.

Illustration for Configuring an Exemplary Control Table

In the example illustrated in FIGS. 6 and 7, the SME has chosen to change the KeyPad_Control RAK table. The data may be displayed as illustrated in Web page 30, FIG. 6.

The window 35 exposes each column from a first Keypad_ID from the table list in the window 32. These columns and their respective data are shown in a tree format.

The name of the keypad is displayed in a dropdown combo box 40. The rows from this RAK table are exposed in the window 41 at the top. At this point a SME can, modify data from one or more of the columns (e.g., tree nodes shown) by double clicking a selected tree node.

FIG. 7 illustrates an example of a SME double clicking the tree node labeled “Domestic”. The SME would be presented with a text box 42 in which they can change the description of a keypad 43 shown to a user to any designation up to a maximum number of characters. The SME can also change an existing sequence of choices by selecting the tree node labeled Seq_Number so that for example a given keypad choice does not show up first in the keypad choice but 2^{nd}, 3^{rd}, last, etc. The tree node labeled Entry_Text is a node that selects any entry to be stored in the application database when the Domestic node is selected by a user. It can also be changed.

Building and Processing Dynamic Menu Objects

As suggested above, Repository of Application Knowledge (RAK) table 58, i.e., the Menu_Control table, has two primary purposes. The Menu_Control table is used by the DAG system to dynamically generate the business application menu. It is the user entry point for all events to be processed by the DAG business application when a user issues a mouse, keyboard action or any other suitable command directed at the menu. The rows created by the SME analyst in this control table will be gathered into a Record Set Object (RSO) and a series of arrays that in one exemplary embodiment will be dynamically interrogated: Each time a user logs, and whenever a user triggers a menu event.

The foregoing actions ensure that changes and additions relative to how the system reacts are available to a user as soon as the SME analyst makes the changes. All computer interface activities in a given DAG business application, e.g., mouse or keyboard events and their corresponding calls to an object are driven by the RSO and arrays built from the Menu_Control table. In one exemplary embodiment, this table is structured as follows: Each row in the table includes the following column field identifiers:

Menu_ID—The name of the menu to be invoked. This ID can be user or application specific. If user specific it is contained in the User table, and is established by the application Systems Administrator when the user is added as a valid application user.

Seq_Number—This is used for documentation, as well as being the ‘Order by’ column to ensure these SUB menu choices are shown on dropdown menus in their correct order.

Menu_Node Type—This field specifies and controls the levels a menu item is given.

Menu_Node Type are; MAIN, level one, or SUB, meaning a sub menu to a MAIN.

Caption—This field defines the caption (name) to be used for this menu item.

Action_Type—This column contains the type of action to be invoked when the menu choice is made. The choices include SHOWFORM, DISPLAY DATA, RUNEXE, ETC.

Action_ID—This is the ID of the function to be invoked. Depending on the

Action_Type the ID is used to access other objects and their RSO.

Building Dynamically Generated Menus (DGM)

The process to interpret the RAK tables and build DGMs is essentially the same regardless of the specific menu to be built. The DAG system extracts the Menu_Control table rows for a chosen Menu_ID and creates an RSO array and dynamically builds the menu each time it is displayed. This ensures that as a SME modifies a menu the changes are reflected to a user the next time they display the menu—without logging off and back on again.

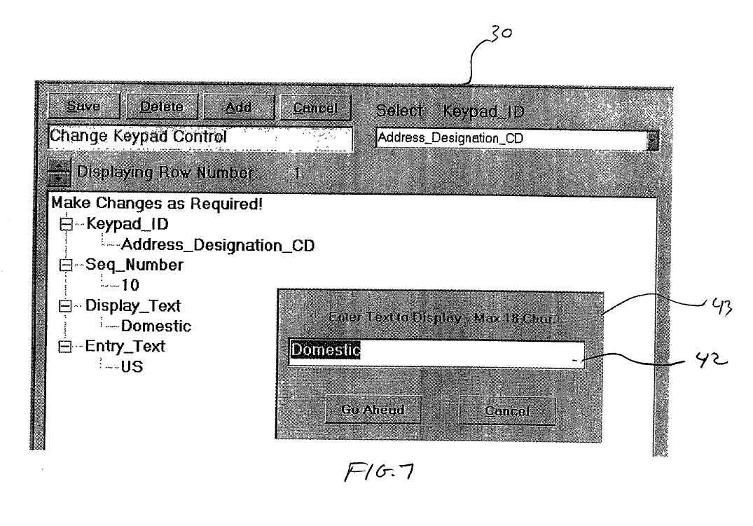

As illustrated in FIG. 8, the Menu_Control table may be processed in one exemplary embodiment as follows:

Subsequent to a user completing a successful system login at step 100, step 102 allows for building or creating a record set object (RSO), for example, from all rows from the Menu_Control table where Menu_ID=the chosen menu. Step 104 allows for creating a series of one or more arrays for each column in the RSO and a invoking the appropriate menu object to interpret the arrays and dynamically build the menu. Step 106 allows to display the menu and its required objects to the user, and step 108 allows to await for a further menu event selected by the user.

Processing Events for Dynamically Generated Menus (DGMs)

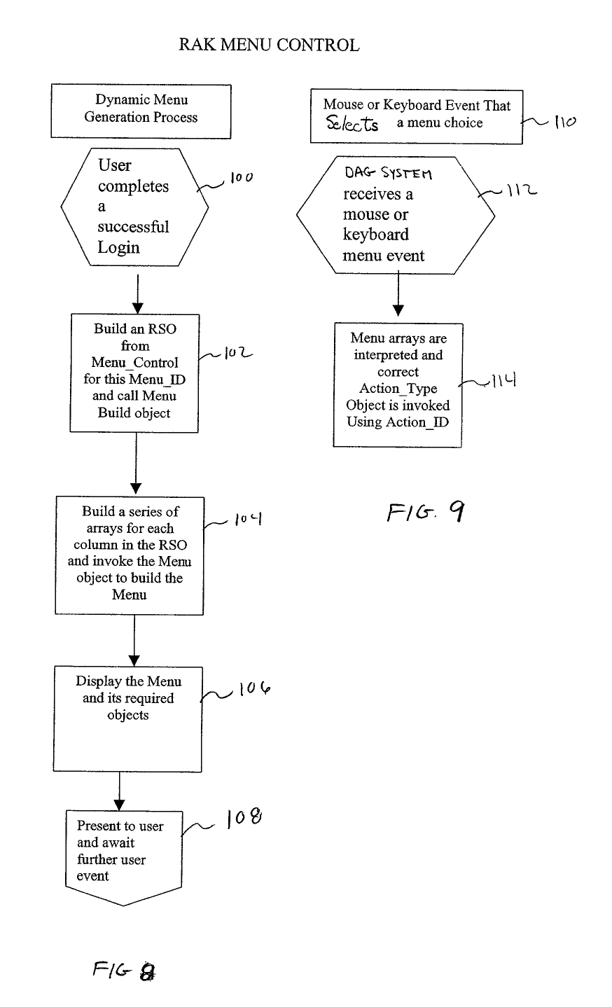

The foregoing process generally applies to any menu built through the DAG system. FIG. 9 illustrates a flow chart of exemplary actions regarding a menu command or event, e.g., mouse, voice, or keyboard event that selects a menu choice as shown at block 110. Subsequent to step 112 wherein the DAG system receives the menu event, as shown at block 114, the selected menu arrays would be interpreted and an appropriate Action_Type object would be invoked using the Action_ID, for example. Thus, when the menu event occurs interrogate the menu arrays and determine the appropriate Action_ID and Action_Type. Then, invoke the appropriate DAG object to process the event.

Building and Processing Dynamic Menu Tree Objects

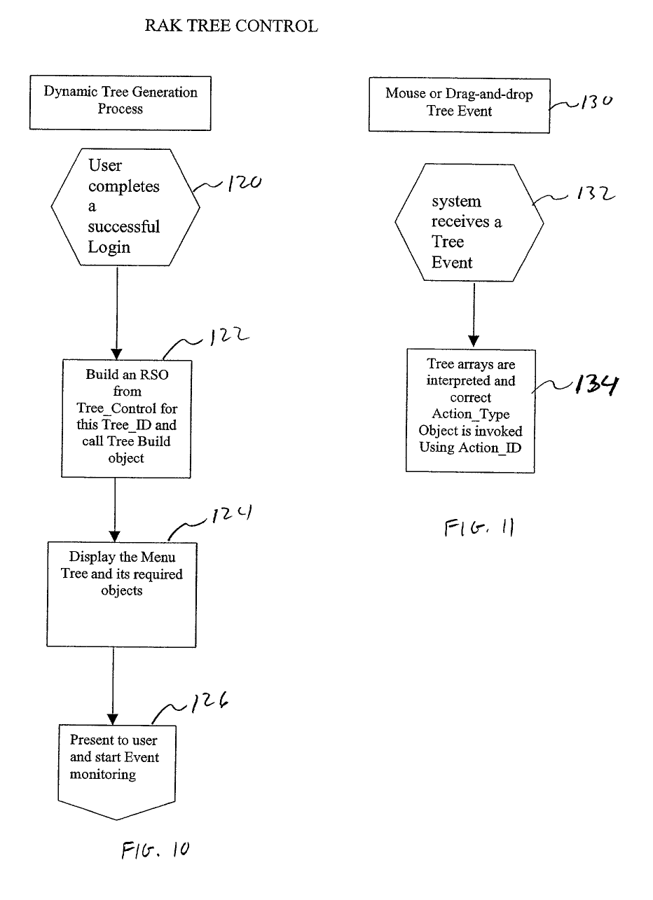

As illustrated in FIGS. 10 and 11, menu trees are one alternate method of allowing a user to invoke system and application functions from an exposed tree structure in lieu of, or in combination with the windows menu discussed in the context of FIGS. 8 and 9. The Repository of Application Knowledge (RAK) table for Tree_Control, block 62 in (FIG. 5), has two primary purposes regarding menu trees. It is used by the system to dynamically generate the business application menu trees that are displayed to a user. It is the entry point for all events to be processed by the business application when a user issues a command action, e.g., a mouse action including drag and drop on a tree node. The rows created by a SME analyst in this control table will be dynamically gathered into an RSO and a series of arrays built and interrogated: Each time a user logs in. This allows the system to dynamically generate a user's menu tree, and whenever a user triggers a tree node event. The foregoing ensures that changes and additions relative to how the system responds are available to a user as soon as the SME analyst makes the changes. This RAK control table generally contains multiple fields that control the building of menu tree displays for a business application as well as specifying the Action_Type and Action_ID to be invoked when a user-driven event triggers respective actions. The SME analyst in defining the specific structure and values for the tree and its nodes populates all of these fields. In one exemplary embodiment these fields are:

Tree_Type—Menu trees all have a Tree-Type of MENU

Tree_ID—This column identifies the tree.

Seq_Number—This is the standard field for RAK control tables, and in this instance is also used for controlling the display order of nodes on the tree.

Node_Type—This is PARENT or CHILD and specifies to the DAG system the structure of nodes on a tree.

Display_Text—This field specifies the text label to be displayed for the node on the tree display.

Show—This field specifies whether a parent node is exposed expanded or collapsed when the tree is invoked.

Icon_Index—This allows different nodes to be displayed with different picture identifiers for easier recognition of their function.

Drag_Drop_IND—This is a true/false field indicating whether this Node_ID can be used in a drag-and-drop event or whether a non-event should occur if a user attempts to perform a drag-and-drop.

Action_Type—This is the type of action to be taken if this node is invoked. Options are the same as for menus.

Action_ID—This column contains the trigger ID for the action to be invoked. These are the same Action_ID's used for menus.

Building Dynamically Generated Trees (DGT)

The process to interpret the RAK tables and build DGT is essentially the same regardless of the menu tree being built. The system extracts the Tree_Control table rows for a chosen Tree_ID and creates a Record Set Object (RSO) array and dynamically builds the tree each time it is displayed. This ensures that as a SME modifies a menu tree, the changes are provided to a user the next time they display the menu—without logging off and back on again. As illustrated in FIG. 10, the process for processing tree control in one exemplary embodiment is as follows:

Subsequent to a user completing a successful system login at step 120, step 122 allows for building or creating a record set object (RSO), for example, from all rows from the Tree_Control table where Tree_ID—the chosen menu. Step 124 allows for creating a series of one or more arrays for each column in the RSO and invoking the appropriate tree object to interpret the arrays and dynamically build the menu tree. Step 126 allows to display the menu tree and its required objects to the user, and start appropriate event monitor. The foregoing process generally applies to any Menu tree built through the DAG system.

FIG. 11 illustrates a flow chart of exemplary actions regarding a tree command or event, e.g., mouse, voice, or keyboard event that selects a tree event as shown at block 130. Subsequent to step 132 wherein the DAG system receives the tree event, as shown at block 134, the selected tree arrays would be interpreted and an appropriate Action_Type object would be invoked using the Action_ID, for example.

Building And Processing Dynamically Generated Form (DGF) Objects Overview

The DAG system and the Repository of Application Knowledge tables to build and process Dynamically Generated Forms (DGF) in one exemplary embodiment comprises a plurality of RAK control tables whenever any form, grid, dialogue box, text box, data tree, keypad, dropdown, number box, etc., needs to be dynamically built and displayed by a user.

Form_Control—This table contains form level attributes, e.g. Form ID, Form Label, data repository name, repository table name, etc. See RAK table 72 in FIG. 5.

Form_Display—The DAG system uses this RAK table to produce dynamically built data entry and data display form. This table contains all field level controlling attributes of a form. See RAK table 74 in FIG. 5.

DropDown_Control—The DAG system uses this RAK table to produce a dynamically built drop down combo box list for a data entry field and is generally used if there are a relatively large number of choices, e.g., 50 states. It is also used if the description of the choices requires more than a few characters to give the user sufficient hints as to which choice is correct, e.g., a patient disposition choice of “Encounter in Progress No Disposition Yet” which could be stored in the repository as “Progress”. See RAK table 76 in FIG. 5.

KeyPad_Control—The DAG system uses this RAK table to produce a relatively small dynamically generated keypad on the data entry screen with a plurality of different key choices. It is used when the SME analyst determines that a short description, e.g., chronic, acute, minor, mild, etc., is sufficient for a user to determine the correct entry, and where the number of choices is moderate, e.g., less than 16. See RAK table 78 in FIG. 5.

Tree_Control (for data trees)—The DAG system uses this RAK table to dynamically produce a tree structure from which a choice can be made by double clicking a node, highlighting a node and pressing enter, or dragging and dropping the node. See RAK table 80 in FIG. 5.

Message_Control—The DAG system uses this RAK table to produce dynamically generated timer messages anytime the business application system determines that an error message needs to be displayed to a user to inform him/her of errors or other situations. See RAK table 70 in FIG. 5.

Coversheet_Control The DAG system uses this RAK table to produce dynamically generated summary display forms when the SME analyst has determined that there is a requirement to expose data from multiple tables within a repository database on a single form. In one exemplary embodiment, this object builds a display form to expose limited data from up to eight tables at a time.

The SME or business analyst determines in each case whether a drop down, keypad or a tree is the proper technique to use for a specific field and situation. In combination, the foregoing tables will control all Dynamically Generated Forms (DGFs) to be displayed in a given application. The DGFs built by the DAG system are fully adaptable to any user need for entry or review of any data.

Form Control, Form Display and Coversheet Display Tables

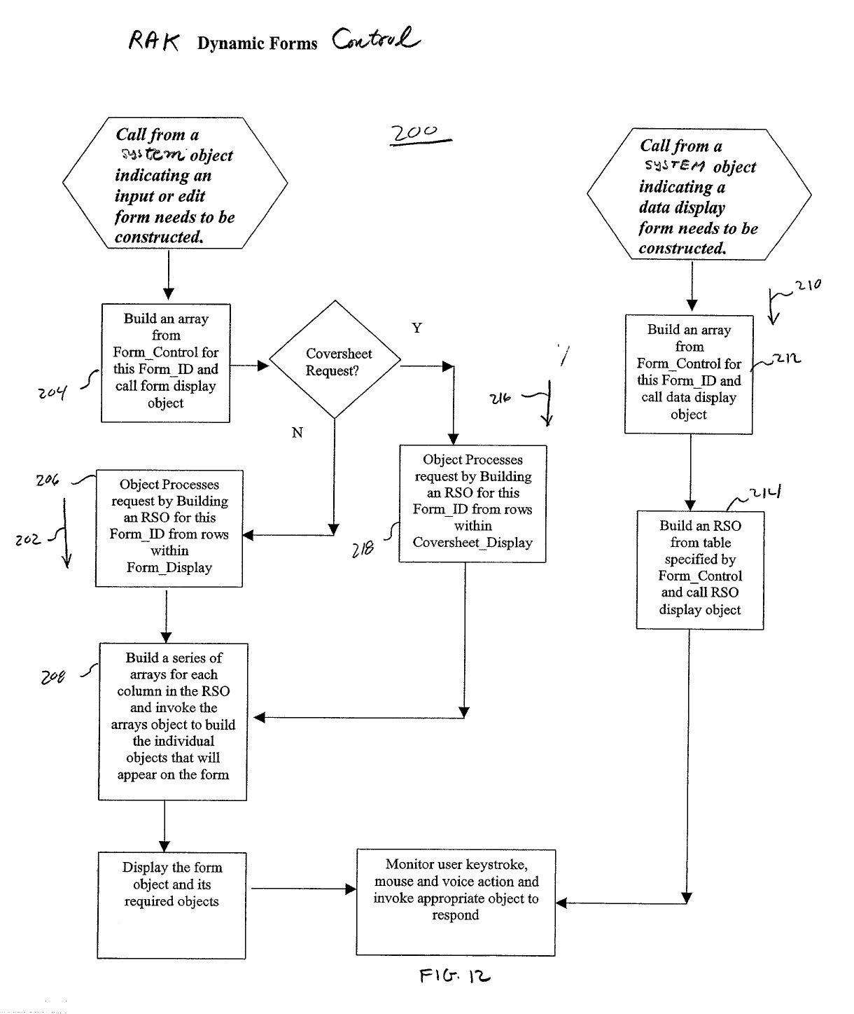

FIG. 12 illustrates a flow chart of a process 200 that may be used to interpret the RAK tables and build DGFs regardless of the form being built. The DAG system extracts the Form_Display table rows for this Form_ID and creates an array and dynamically builds the form each time it is displayed. This ensures that as a SME modifies a form the changes are reflected to a user the next time they display the form—without logging off and back on again. The process in one exemplary embodiment is as follows:

The Form_Control table Object:

As represented by flow path 202, and assuming no coversheet is requested, then blocks 204, 206 and 208 allow for:

Creating a record set object (RSO) from all rows from the Form_Control table (FIG. 5) where Formn_ID=the chosen form. Form_ID can be chosen from a menu, tree menu or another form.

Creating a series of one or more arrays for each column in the RSO.

Calling or invoking the appropriate Form object to interpret the arrays and dynamically build component objects that direct the DAG system to invoke the form display object row for each Formn_ID. By way of example, this row includes:

Seq_Number

Form_ID—This is used to identify all rows of the Form_Display RAK that are to bDelete footere gathered into an RSO and interrogated to generate this DGF.

Form_Label (English)—This is the title of the form.

Spanish_Form_Label (Spanish)

Table_Name—This is the name of the data repository table where the entered data is stored.

Database_Name—This field specifies the DAG system recognized name of the repository database. The data required to access the repository database is contained in the System_Control RAK.

The Form_Display table Object:

Within the Form_Display RAK there are one or more rows for every listed FORM_ID. Each row includes the appropriate information the form display objects require to build and process a form ID. As represented by flow path 210, blocks 212 and 214 allow for:

Creating a record set object (RSO) from all rows from the Form_Display table WHERE Form_ID=the chosen form. Form_ID can be chosen from a menu, tree menu or another form.

Creating a series of one or more arrays for each column in the RSO, and.

Calling the appropriate form display object to interpret the arrays and dynamically build component objects that direct the MERLIN build, display and process the form and all objects on the form.

In one exemplary embodiment, the Form-Display RAK table includes information in the following columns:

Form_ID—This column contains the FORM_ID itself

Seq_Number—this column is used for documentation purposes as well as for controlling the display order of fields on a form object.

Field_Name—This column contains the name of the field to be displayed, added, updated, etc. The name is as it is identified in the business application database.

Key_IND—Indicates whether this field is a key to the application database table row.

Key fields cannot be edited once saved to the repository.

Label_Display_Text—This column contains the label to display for the indicated

Field_Name when that field is displayed. A user doesn't want to see a database field name.

Spanish_Label_Display_Text—This column may be optionally used as an alternative to the Label_Display_Text when the Language_Preference_CD in the USER table in the business application database is checked to see if their language preference is Spanish or any other language other than English. This would also work for any language preference by adding additional Language_Label_Display_Text columns to the Form_Display table for other languages.

Display_Size—This column controls the display size for this field and the allowed input size by a user. It reflects the actual size of a field in the application's data repository.

Data_Link_Number—This column contains a number that the system utilizes if one fields value needs to be entered on more than one form during initial data entry, e.g. a new patient and the various forms required to gather all pertinent data may be inputted from more than one form. This technique carries forward all fields that are required to be duplicated on each form.

Required_IND—This TRUE/FALSE column indicates whether entry into this field is required. If checked, then the system will place an asterisk next to the field name on display to indicate to the user that entry is required and not let the user to save the data until an entry is made.

Help_IND—This column indicates whether there is specific help provided that addresses only this field. If true then a help object on the menu will appear when this field gets focus. When pressed this object will display the specific help for this field.

Field_Format_CD—This column contains the field format for entry of information.

The system will display a specific format control object for these fields when a user attempts to enter or update information in the field. The Field_Format_CD Objects currently defined are:

Data_Type—This column contains the data type associated with this field in the application data table.

Default_Value—This column contains the specific default value a SME specifies. The value is displayed when a form object is presented so a user does not need to enter data except when it is other than the default.

Yes_DropDown_ID—This column contains the specific Dropdown_ID to be used by the Dropdown object when the Field_Format_CD for this row is DROPDOWN. The Dropdown object also uses this column when the Field_Format_CD is YES/NO and the SME has determined that the following field (Field_Format_CD of RESULT) should only be populated when the YES/NO field is answered YES, and that it should be populated from a Dropdown. The Dropdown_ID identifies the specific dropdown.

No_Dropdown_ID—The Dropdown object uses this column when the Field_Format_CD is YES/NO and the SME has determined that the following field (Field_Format_CD of RESULT) should only be populated when the YES/NO field is answered NO, and that it should be populated from a Dropdown. The Dropdown_ID identifies the specific dropdown.

Yes_Tree_ID—This column contains the specific Tree_ID to be used by the Data Tree object when the Field_Format_CD for this row is TREE. The Data Tree object also uses this column when the Field_Format_CD is YES/NO field and the SME has determined that the following field (Field_Format_CD of RESULT) should only be populated when the YES/NO field is answered YES, and that it should be populated from a Tree. The Tree_ID identifies the specific Tree.

No_Tree_ID—The Data Tree object uses this column when the Field_Format_CD is YES/NO and the SME has determined that the following field (Field_Format_CD of RESULT) should only be populated when the YES/NO field is answered NO, and that it should be populated from a Tree. The Tree_ID identifies the specific Data Tree.

Yes_Keypad_ID—This column contains the specific Keypad_ID to be used by the Keypad object when the Field_Format_CD for this row is KEYPAD. The Keypad object also uses this column when the Field_Format_CD is YES/NO and the SME has determined that the following field (Field_Format_CD of RESULT) should only be populated when the YES/NO field is answered YES, and that it should be populated from a Keypad. The Keypad_ID identifies the specific Keypad.

No_Keypad_ID—The Keypad object uses this column when the Field_Format_CD is YES/NO and the SME has determined that the following field (Field_Format_CD of RESULT) should only be populated when the YES/NO field is answered NO, and that it should be populated from a Keypad. The Keypad_ID identifies the specific Keypad.

Yes_Format_CD—The Format_CD object uses this column when the

Field_Format_CD is YES/NO and the SME has determined that the following field (Field_Format_CD of RESULT) should only be populated when the YES/NO field is answered YES, and that it should be populated from a Format_CD. The Format_CD identifies the specific Format_CD.

No_Format_CD—The Format_CD object uses this column when the Field_Format_CD is YES/NO and the SME has determined that the following field (Field_Format_CD of RESULT) should only be populated when the YESNO is answered NO, and that it should be populated from a Format_CD. The Format_CD identifies the specific Format_CD.

Yes_Form_ID—The Format_CD object uses this column when the Field_Format_CD is YES/NO and the SME has determined that a Yes response should immediately cause a different form to be exposed and completed.

No_Form ID—The Format_CD object uses this column when the Field_Format_CD is YES/NO and the SME has determined that a No response should immediately cause a different form to be exposed and completed

Quick_Tip—This column contains a quick tip to be displayed when a user moves their mouse to a field's label and right clicks their mouse. A quick tip is just a simple hint as to what the system expects from them for this field.

Message_ID—This column contains the specific Message_ID to be used by the Timer Message object when an error condition is encountered.

Field Format Code Objects

The list below comprises and exemplary list of formatting objects. It will be appreciated that such a list may be readily updated as new objects are defined.

TEXT—Alphanumeric entry up to 30 characters.

LONGTEXT—Alphanumeric entry up to 255 characters

MEMO—Alphanumeric entry up to 65,000 characters

NUMBER—Integers and decimals

COMDATE—Accepts dates in the format MM/DD/YYYY

COMTIME—Accepts time in the format of a 12 hour clock

MILDATE—Accepts dates in the format DDMMMYYYY (14JAN2001)

MILTIME—Accepts time in the format of a 24 hour clock

YES/NO—TRUE/FALSE, shown as Y or N, but stored as 0, −1

KEYPAD—Indicates the data must be selected from a Keypad display object

DROPDOWN—Indicates the data must be selected from a Dropdown display object

TREE—Indicates the data must be selected from a Data Tree display object

RESULT—Special object that receives input only from another object, e.g. Data Tree, Keypad, Dropdown, Text, Number, alternate Form object, etc., as opposed to direct user input. RESULT is used after a YES/NO option when entry in the RESULT field is required only if a previous answer dictates that it is necessary. Also used to automatically invoke a different Form object based on entered answers.

ZIP—Allows 9 digit zip in the format, NNNNN-NNNN

PHONE—Allows 10 digit phone entry in the format, NNN.NNN.NNNN

YEAR—Allows 4 digit years within the range 1880-2100

SSN—Allows 9 digit SSN entry in the format, NNN-NN-NNNN

PICTURE—Picture object used for digital images, photos, graphics, etc.

RTF—Allows for unlimited entry of both images and graphics.

BLOOD. This is a format that takes in up to 3 digits followed by an/followed by up to 3 digits. Example, 90/130, 110/120, etc.

MILPATID—Allows a 2 digit FMP followed by an SSN. It is formatted 20/345-56-6789

SHORTID. This is first initial last name and last four of SSN. The object associated with this Format Code automatically generates it.

Coversheet Display Processing

The Coversheet_Display table in one exemplary embodiment is structured and processed as follows:

Within the Coversheet_Display RAK table there are one or more rows for every listed FORM_ID. Each row contains the required information the coversheet display objects require to build and process a form ID. As represented by flow path 216, blocks 218 and 208 allow for structuring and processing the Coversheet_Display table by:

Creating a record set object (RSO) from all rows from the Coversheet_Display table WHERE Form_ID=the chosen form. Form_ID can be chosen from a menu, tree menu or another form, creating a series of one or more arrays for each column in the RSO and calling the appropriate coversheet display object to interpret the arrays and dynamically build component objects that direct the system to build, display and process the form and all objects on the form.

Coversheet_Display generally exposes limited data and the date the row was created. In one exemplary embodiment, the coversheet display exposes up to 6 rows of limited data and provides a scroll bar if more that six rows exists. Double clicking any of the limited displays will automatically expose the complete repository table.

In one exemplary embodiment, the Coversheet_Display RAK includes information in the following columns:

Coversheet_ID—This column contains the Coversheet_ID itself.

SetNumber—this column is used for documentation purposes

Table_{—}1—This column contains the name of the table from which data will be displayed in the first of eight locations on the coversheet form. The name is as it is identified in the business application database.

Table_{—}1_Form_ID—This column is only used if a user double clicks this table display. The system automatically calls the DISPLAYDATA object with this Form_ID.

Table_{—}1_Data_Field_{—}1—This column contains the name of the field to be displayed from table 1. # Indicates whether this field is a key to the application database table row. Key fields cannot be edited once saved to the repository.

Table_{—}2—This column contains the name of the table from which data will be displayed in the first of eight locations on the coversheet form. The name is as it is identified in the business application database.

Table_{—}2_Form_ID—This column is only used if a user double clicks this table display. Merlin automatically calls the DISPLAYDATA object with this Form_ID.

Table_{—}2_Data_Field_{—}1—This column contains the name of the field to be displayed from table 1. Indicates whether this field is a key to the application database table row. Key fields cannot be edited once saved to the repository.

The foregoing columns in the RSO are repeated in one embodiment for eight tables with one exception. A pair of tables is allowed to display multiple fields plus the date a given row was created.

Dropdown, Keypads, and Data Trees

Building and Processing Data Entry Objects that Limit a User's Selection for a field:

The Repository of Application Knowledge (RAK) tables—DropDown_Control, KeyPad_Control, and Tree_Control (for data trees) all share the same basic purpose. That is, each is a system object for presenting specific choices from which a user can select only valid entries that are specified by the SME. These tables and the objects that utilize them:

Save data entry time by avoiding keystrokes,

Eliminate data entry errors by providing a specific selection of SME created choices for field entry from which a user can choose.

Reduce data storage requirements since the DAG system conveniently stores a code to indicate a users choice for a specific field, not the description that is shown to a user in order to give them sufficient data with which to make a selection.

These objects give the SME analyst at least three options in how to present specific choices for a user doing data entry on a DGF.

DropDown_Control—As suggested above, this object produces a dynamically built drop down combo box list for a data entry field and is used if there are a relatively large number of choices, e.g., 50 states. It is also used if the description of the choices requires more than a few characters to give the user sufficient hints as to which choice is correct, e.g., a patient disposition choice of “Encounter in Progress. No disposition Yet” which could be stored in the repository database as just “Progress”.

KeyPad_Control—This object produces a relatively small dynamically generated keypad on the data entry screen with, for example, 3-15 different key choices. It is used when the SME analyst determines that a relatively short description, e.g., chronic, acute, minor, mild, etc. is sufficient for a user to determine the correct entry, and where the number of choices is moderate, e.g., less than 16.

Tree_Control (Data Entry)—This object is very analogous to the DropDown_Control, but instead of dynamically generating a drop down list, it generates a tree structure from which a choice can be made by double clicking a node, highlighting a node and pressing enter, or dragging and dropping the node.

The SME or business analyst determines in each case whether a drop down, keypad or a tree is the proper technique to use for a specific field and situation.

Dropdown, Data Tree and Keypad Control Objects

These control objects are invoked anytime the Form_Display object determines that a field to be displayed on a form has a specific set of possible values from which a user must choose. The column Field_Format_CD for a field being set to DROPDOWN, KEYPAD, or TREE indicates this.

The tables used by these objects contain all values for every field in an application database for which only certain values are valid. These tables are populated by a SME analyst and used to:

Automatically ensure that only valid values are entered into appropriate fields. Automatically build lists from the specified control table when a user attempts to input or change data in that field. When displayed to a user, these lists use complete English descriptions of the value sets e.g. State of ‘WA=Washington’ rather than ‘WA, address type of ‘FA=Foreign Address’ rather than ‘FA’, and person type of ‘IMF=Immediate family Member’ rather the ‘IMF’.

Automatically store a the value set code in the database rather than the complete description a user sees, This is done to save user-input keystrokes and to save relatively large amounts of storage space.

It is completely up to the SME as to which of the three control tables he or she chooses to use. As with all other RAK tables and their objects, the list choices will be dynamically interrogated each time one of these objects and their table is invoked. This ensures that changes and additions relative to how the system reacts to a request are available to a user as soon as the SME analyst makes the changes.

FIG. 13 illustrates a flow chart of a process 300 for respectively constructing dropdown, keypad and date trees objected in accordance with aspects of the present invention.

DropDown_Control Table

This control table and corresponding process, as conceptualized by flow path 302 in FIG. 13, is invoked anytime the Form_Display table object determines that a field to be displayed on a form or grid has a specific set of values from which a user can choose, and that these values are to be displayed on a Drop Down list.

This table contains data for fields in an application database for which only certain values are valid. The table is populated by a SME analyst and is used to:

Automatically ensure that only valid values are entered into appropriate fields.

Automatically build a dropdown list from the specified Dropdown_ID when a user attempts to input or change data in that field. When displayed to a user, this dropdown uses linguistic descriptions of the choices to display to a user.

Automatically store a the code in the database rather than the complete description a user sees. This is done to save user-input keystrokes and to save massive amounts of storage space.

As with all other RAK tables and their objects, the dropdown information will be dynamically interrogated each time this table is invoked. This ensures that changes and additions relative to how the system reacts to a request are available to a user as soon as the SME analyst makes the changes.

The DropDown_Control RAK table includes four fields or columns, all of which are populated by the SME analyst in defining the specific values for fields in the application database. These fields are:

DropDown_ID—This column contains one or more Dropdown ID's for an application database table. If the dropdown is always to be used for data entry on a field the Dropdown ID is specified in the Yes_Dropdown_ID column of the Form_Display table. Use of the No_Dropdown_ID is specified in the document Field Format Codes Seq_Number—This is the standard field for RAK control tables, and in this instance is used for controlling the display order of the drop-down list as well as for documentation purposes.

Entry_Text—This field contains the value that will be stored in the application database if the user selects this choice on a drop-down.

Drop_Down_Code_Description—This field contains the full drop down description that will be shown to a user.

KeyPad_Control Table

This control table and corresponding process, as conceptualized by flow path 304 in FIG. 13 is invoked anytime the Form_Display table object determines that a field to be displayed has a specific set of values from which a user can choose, and that these values are to be displayed on a Keypad.

This table contains data for fields in an application database for which only certain values are valid. The table is populated by a SME analyst and is used to:

Automatically ensure that only valid values are entered into appropriate fields.

Automatically build a keypad from the specified Keypad_ID when a user attempts to input or change data in that field. When displayed to a user, this keypad uses short English descriptions of the choices e.g. chronic, mild moderate, acute, etc. These choices are then stored in the application's repository database.

Automatically store a the code in the database rather than the complete description a user sees. This is done to save user-input keystrokes and to save massive amounts of storage space.

As with all other RAK tables and their processes, the keypad information will be dynamically interrogated each time this table is invoked. This ensures that changes and additions relative to how the system reacts to a request are available to a user as soon as the SME analyst makes the changes.

The KeyPad_Control RAK table contains four fields or columns, all of which are populated by the SME analyst in defining the specific values for fields in the application database. These fields are:

Seq_Number—This is the standard field for RAK control tables, and in this instance is used for controlling the display order on drop-down as well as for documentation purposes.

Keypad_ID—This field contains ID of the specific keypad.

Display_Text—This field contains the text that will be shown to a user on a key.

Entry_Text—This field contains the text that will be Stored in the application database table.

Tree_Control (Data Tree) Table

This control table and corresponding process, as conceptualized by flow path 306 in FIG. 13, is invoked anytime the Form_Display table object determines that a field to be displayed has a specific set of values from which a user can choose, and that these values are to be displayed on a Tree. This table contains data for fields in an application database for which only certain values are valid. The table is populated by a SME analyst and is used to: Automatically ensure that only valid values are entered into appropriate fields. Automatically build a Tree from the specified Tree_ID when a user attempts to input or change data in that field. When displayed to a user, this Tree uses linguistic descriptions of the choices e.g. Pulse of 40-90 where each choice is a child node of a more descriptive Parent node. As with all other RAK tables and their processes, the Tree information will be dynamically interrogated each time this table is invoked. This ensures that changes and additions relative to how the system reacts to a request are available to a user as soon as the SME analyst makes the changes.

This RAK control table contains multiple fields that control the building of Data Tree displays for a business application when a user triggers one of the tree's nodes. Certain fields in this table are not required for Data Trees and will not, therefore, be interrogated when a Data Tree is requested. The SME analyst in defining the specific structure and values for the tree and its Nodes populates the following fields. These fields are:

Tree-Type—Data trees all have a Tree_Type of DATA

Tree_ID—This column identifies the tree.

Seq_Number—This is the standard field for RAK control tables, and in this instance is also used for controlling the display order of nodes on the tree.

Node_Type—This is PARENT or CHILD and specifies to the MERLIN the structure of nodes on a tree.

Display_Text—This field specifies the text label to be displayed for the node on the tree display.

Show—This field specifies whether a parent node is exposed expanded or collapsed when the tree is invoked.

Icon_Index—This allows different nodes to be displayed with different picture identifiers for easier recognition of their function.

Drag_Drop_IND—This is a true/false field indicating whether this Node_ID can be used in a drag-and-drop event or whether a non-event should occur if a user attempts to perform a drag-and-drop.

Dynamic Data Analysis Object And Repeating

As suggested above, the Data_Analysis_Control RAK table (block 54 is FIG. 5) is the control point for application data to specify additional functions to be performed on the applications data such as a tickler function to automatically notify a user of a situation occurring in their data, e.g. a date or time in a specific field in a specific table meets user established parameters. This RAK table is also used where a user specifies such functions as the parameters driving a trending analysis for specific data in a specific table. The Data_Reporting_Control RAK table (block 56 in FIG. 5) is the control point for an easy to use reporting wizard that allows a user to quickly specify what they wish to see on a report. Example, show me all patients who are allergic to food where the food is tomato.

Dynamic Message Control Object

The Repository of Application Knowledge (RAK) table 70 (FIG. 5), i.e., Message_Control table is invoked anytime the business application system determines that a text box timer message needs to be displayed to a user to inform him or her of errors or other situations of which they need to be aware. In one exemplary embodiment, this RAK control table contains four fields, all of which are populated by the SME analyst in defining the business application to be built and executed. These fields are:

Message_ID—This is the ID of the message row to be interpreted in order to display a message to a user.

Seq_Number—This is the standard field for RAK control tables, and in this instance is used only for documentation purposes.

Message_Display_In_Seconds—This field will be used to override the system standard established in the applications System_Control table. If this field exists, it specifies the length of time in milliseconds that a message will be displayed.

Message—this field contains the message text to be displayed.

As with all other RAK tables and their processes, the Message_ID RSO will be dynamically interrogated each time this object is called. This ensures that changes and additions relative to how the system reacts to a message are available to a user as soon as the SME analyst makes the changes.

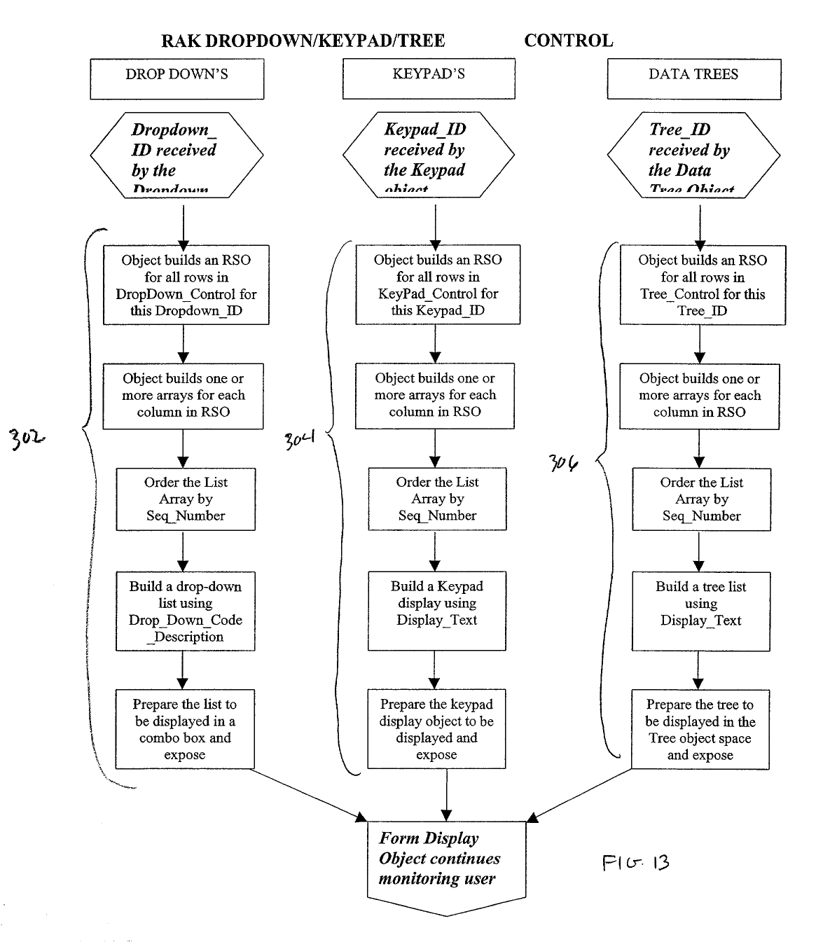

FIG. 14 illustrates a flow chart 400 with exemplary steps for processing RAK table 70. (FIG. 5).

Once a Message_ID is recorded at block 402, then that Message_ID is located in an array built for RAK table 70 at block 404. As shown in decision block 406, assuming a message display includes a predefined timer value, e.g., in milliseconds or any other suitable time unit, then at block 408 a timer message is displayed using time override value in the message row prior to returning to monitoring user-driven events at block 412. As further shown in decision block 406, assuming the message display does not include the timer value, then at block 410, the timer message would be displayed using a timer value from system control prior to returning to event monitoring at block 412.

Dynamically Generated Search (DGS) Object

Building and Processing Dynamic Search Objects

All application databases are built around one highest level key field be it Patient ID, Subject ID in Clinical trials, Client, Customer, Driver in trucking, etc. When any Action_ID is invoked that requires the DAG system accessing an RSO from the application database for this key field it is a requirement that the user have established this RSO prior to invoking the Action_ID. A user accomplishes this through a DGS.

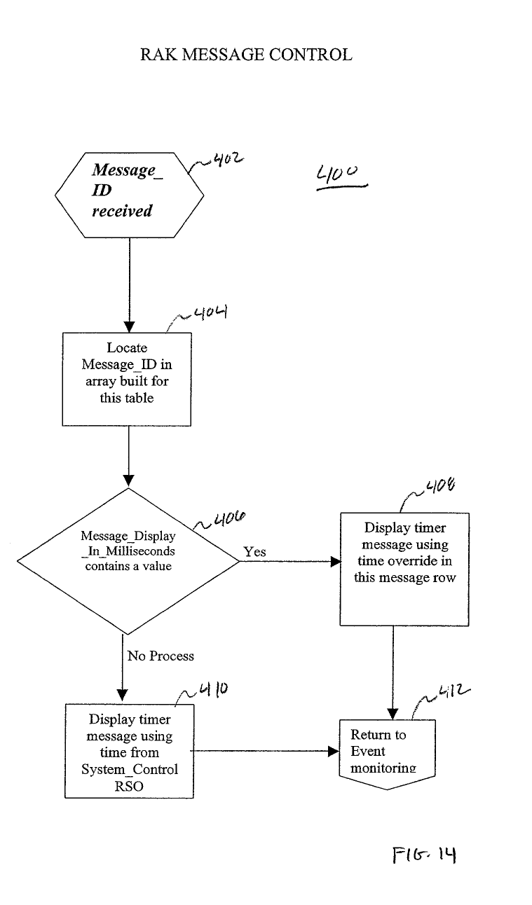

One exemplary process to interpret the RAK tables and build the DGS is as follows. The DAG system extracts the Search_Control table rows for this Search_ID, creates an array and dynamically builds the search form each time it is displayed. This ensures that as a SME modifies a search form the changes are reflected to a user the next time they display the form—without logging off and back on again. FIG. 15 illustrates an exemplary flow chart 500 for creating a Search Control Object. More specifically, as shown at steps 502 through 506, upon receiving a search request the process allows to create a record set object (RSO) from all rows from the Search_Control table where Search_ID=the chosen form. Search_ID can be chosen from a menu, tree menu or another form. The process further allows to create a series of one or more arrays for each column in the RSO. A call to the appropriate search object is performed to interpret the arrays and dynamically build component objects that direct the DAG system to invoke the search object.

The Search_Control RAK table generally includes information in the following columns

Search_ID

Seq_Number

Database_Name—points to the System Configurable for real name and path.

Table_Name

Field Name—all for this Search_ID are gathered into a combo box for user to choose which field to search on.

Key Field—This yes/no field indicates which field is used when a selected patient, subject, etc., is selected after a search, as generally depicted in FIG. 16.

Field_Format_CD—same as for Form_Display.

Search_Form_Label—label presented on search form

The foregoing process applies to any search for a specific table row in application database. This search usually is invoked when a users wishes to open a business application's users, client, patient, account, etc. for the purpose of reviewing, adding to, or updating information. The searching process can be further used to search for any specific row in a table as long as the search criteria are defined in the RAK tables that control searches. In yet another searching aspect, a user may be allowed to select a different drop down list than the system presents. For example a user selects a different choice from the tables to search drop down list. The system then automatically changes the criteria drop down list to match the chosen Search_ID.

The process to search conceptually comprises using a LIKE statement in which the system assumes the user has entered less than a complete entry for the search criteria. As with all other RAK tables and their corresponding processes, the search control information will be dynamically interrogated each time this search process is invoked. This ensures that changes and additions relative to how the system reacts to a search request are available to a user as soon as the SME analyst makes the changes.

Processing Dynamic Search Objects

In one exemplary embodiment a user can search on one and only one table at a time. This table is as specified in the Select table to search drop down list on the DGS form. Further, a user can search on from one to three fields as specified in the combination of the drop down list of fields to search and the associated criteria text box in which they enter their search criteria. If a user requests a search on more than one field the SQL statement defaults to an AND condition, e.g. Chosen Table WHERE Field 1 AND Field 2 AND Field 3 are TRUE. Display search results may be in a wide grid display available. This would allow the users to sort on any of the displayed columns by clicking on the corresponding label of the column they wish to sort on.

Dynamically Generated Voice Command Objects

Processing Dynamic Voice Command Objects

The voice control RAK table 60 (FIG. 5) is the user entry point for all events to be processed by a given business application constructed in accordance with aspects of the present invention when those events are called for by a user's utterance of a voice command. As with all other RAK tables and their processes, the RSO for all voice command rows created by a SME analyst will be dynamically interrogated each time a voice call occurs. This ensures that changes and additions relative to how the system reacts to a voice call are available to a user as soon as the SME analyst makes the changes. All business application voice calls and their corresponding actions can be found within one of the repository of Application Knowledge (RAK) Voice_Control table rows. The table is structured as follows:

In one exemplary embodiment, each row includes the following columns:

Seq_Numnber—This is used for documentation, as well as being the key to the voice call row that is passed to the voice software engine at system startup.

Command_Voice_Call—This column contains the voice utterance (words in a phrase) that invokes an event or keystrokes when the application is notified by the voice engine that one of these utterances has been heard. Through the voice SDK, the DAG system passes to the voice engine a complete array of these unique voice utterances along with the code to return to the application when one of these utterances is heard. The code is a sequence number that corresponds to a number in the Seq_Number column within the Voice_Control table. The actions to be taken by the system application associated with this event will be found in this row just as if a keystroke combination was pressed, or the mouse was clicked. The SME analyst can specify that all events within the business application can be triggered by a voice call utterance, or that only certain events can be triggered by voice.

Action_Type—This is the type of command uttered.

Action_ID—This is the ID of the action to be invoked, or it's the actual set of keystrokes if the Action_Type was KEYSTROKE.

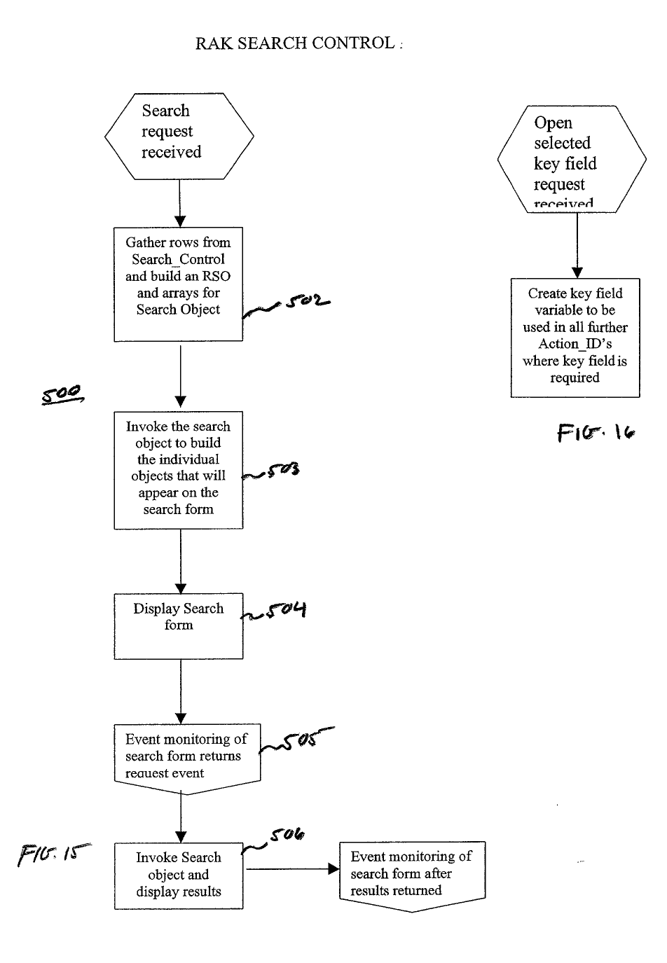

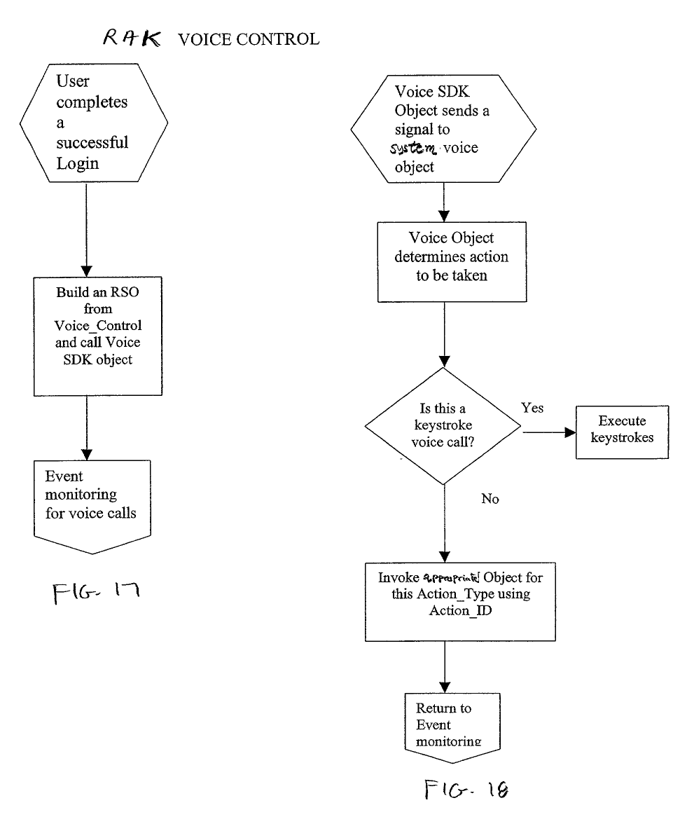

FIGS. 17 and 18 illustrate respective flow charts with exemplary actions for processing the voice control table. It will be appreciated by those skilled in the art that the operational interrelationships depicted in FIGS. 17 and 18 are analogous to the processing of any user-driven commands with the exception that the form of the command comprises a voice command, as opposed to a mouse click, or keystrokes, etc.

FIG. 19 illustrates exemplary details regarding a computerized applications generator system 12 for developing an electronic records management system customizable to meet the ongoing information needs of users of a given enterprise application. The applications generator system includes a memory 600 for storing a plurality of control tables configurable by an expert in the enterprise application, as discussed above in the context of FIG. 5. In one exemplary embodiment a first set of the control tables is configurable to define system-level operational functions. A second set of the control tables is configurable to define a selected input medium or vehicle for uploading information into a repository database 602. A third set of the control tables is configurable to define a selected output medium or vehicle for downloading information from the database 602. An input/output device, e.g., any of the terminals 14, 16, 18 as discussed in the context of FIG. 1, is provided for accessing the plurality of control tables and populating each control table with prescribed rules provided by the expert for invoking a respective action in response to a user-triggered event. A processor 604 is configured to process the control tables and construct a respective record set object array corresponding to the rules provided by the expert to build in response to each constructed record set object array a customized records management system, with the system being accessible by the users through the selected input and output mediums in accordance with the prescribed rules provided by the expert.

The present invention can be embodied in the form of computer-implemented processes and apparatus for practicing those processes. The present invention can also be embodied in the form of computer program code containing computer-readable instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose computer, the computer program code segments configure the computer to create specific logic circuits or processing modules.

To further facilitate understanding of some of the capabilities of the present invention and its simplicity of use for non-programmers, Appendix 2 to this specification includes a “User's Guide”. Both in Appendixes 1 and 2, the assignee of the present invention colloquially refers to the applications generator system embodying aspects of the present invention as the Merlin applications generator system or Merlin wizard.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Editing an existing script.

If you wish to edit a script that has been saved, press File and Open. You will be presented with a list of your existing macro scripts.

This form allows you to open a macro, Play a macro, delete macros that are no longer needed, and print a list of your macros.

Playing Your Recorded Script

There are multiple methods you can use to play your macro scripts.

1. You can play from the DIMR while you are building or editing a script.

2. You can issue a voice command if you are voice activated.

3. You can login to the DIMR and choose to Play macros, or

4. You can press File and then Play. This will expose a list of your scripts as seen below. From this you can highlight a script and click Play on the menu bar, or you can double click your choice and it will be played.

Sharing Your Scripts With Others or Using Scripts Others Have Created

This feature allows you to acquire scripts others have created and use them as your own without having to create them from scratch.

To acquire a script that someone else has created, simply choose Insert and Insert from Shared. You will be presented with a list of macros by user.

Choose the user and then choose the script in the right hand window, and then double click or choose Insert on the menu.

If you are inserting from shared without a script open in the add/edit form you will be given the entire script including its Start In application.

If you are inserting from shared with a new or old script already open in the add/edit form you will be asked if you wish to either Switch to the application the inserted macro starts in or to simply include the macro script lines without performing a Switch to.

You will now have a new script presented in your add/edit script window just as if you had created it line by line.

What is claimed is:

1. A computerized method for developing an electronic records management system customizable to meet the ongoing information needs of users of a given enterprise application, the method comprising:
providing a plurality of control tables configurable by an expert in the enterprise application, with a first set of the control tables being configurable to define system-level operational functions, with a second set of the control tables being configurable to define a selected input medium for uploading information into a repository database, and with a third set of the control tables being configurable to define a selected output medium for downloading information from the database;
providing an input/output device for accessing the plurality of control tables;
populating each control table with prescribed rules provided by the expert through the input/output device for invoking a respective action in response to a user-triggered event; and
processing the control tables to construct a respective record set object array corresponding to the rules provided by the expert to build in response to each constructed record set object array a customized records management system, with the system being accessible by the users through the selected input and output mediums in accordance with the prescribed rules provided by the expert.

2. The computerized method of claim 1 wherein the first control table set configurable to define the selected system-level operational functions comprises a menu control table including a main menu and a plurality of sub-menu choices invocable by a respective user-triggered event.

3. The computerized method of claim 2 wherein the first control table set configurable to define the selected system-level operational functions further comprises a menu tree control table including a menu tree and a plurality of tree nodes invocable by a respective user-triggered event.

4. The computerized method of claim 2 wherein the menu control table is linkable to a search control table configurable to define searchable keys for retrieving information from the database.

5. The computerized method of claim 2 wherein the menu control table is linkable to a data report control table configurable to activate a reporting wizard for generating reports from the database.

6. The computerized method of claim 2 wherein the menu control table is linkable to a menu tree control table including a menu tree and a plurality of tree nodes invocable by a respective user-triggered event.

7. The computerized method of claim 2 wherein the menu control table is linkable to an executable control table configurable to interface with programs external to the customized records management system.

8. The computerized method of claim 1 wherein the second control table set configurable to define the selected input medium for uploading information into the repository database comprises a form control table for gathering input data.

9. The computerized method of claim 8 wherein the form control table is selected from the group consisting of a form display control table, a data tree control table, a dropdown control table, a keypad control table, and a coversheet control table.

10. The computerized method of claim 1 wherein the third control table set configurable to define the selected output medium for downloading information from the repository database comprises a form display control table for displaying output data.

11. The computerized method of claim 1 further comprising a data analysis control table configurable to perform predefined analysis on selected data in the database.

12. The computerized method of claim 5 wherein the user-triggered event comprises a computer-detectable interface event selected from the group consisting of a computer mouse event, a keyboard event, a pointer event, and a user-voice utterance event.

13. The computerized method of claim 1 wherein the customized records system is rebuildable to include any new customization as may be required by the ongoing information needs of the enterprise application based on any new prescribed rules provided by the expert to repopulate the control tables.

14. The computerized method of claim 1 wherein the customized records system is accessible to users and experts via a communications network selected from the group consisting of a local area network, a wide area network, an intranet, and the Internet.

15. A computerized applications generator system for developing an electronic records management system customizable to meet the ongoing information needs of users of a given enterprise application, the applications generator system:
memory for storing a plurality of control tables configurable by an expert in the enterprise application, with a first set of the control tables being configurable to define system-level operational functions, with a second set of the control tables being configurable to define a selected input medium for uploading information into a repository database, and with a third set of the control tables being configurable to define a selected output medium for downloading information from the database;
an input/output device for accessing the plurality of control tables and populating each control table with prescribed rules provided by the expert for invoking a respective action in response to a user-triggered event; and
a processor configured to process the control tables and construct a respective record set object array corresponding to the rules provided by the expert to build in response to each constructed record set object array a customized records management system, with the system being accessible by the users through the selected input and output mediums in accordance with the prescribed rules provided by the expert.

16. The computerized system of claim 15 wherein the first control table set configurable to define the selected system-level operational functions comprises a menu control table including a main menu and a plurality of sub-menu choices invocable by a respective user-triggered event.

17. The computerized system of claim 16 wherein the first control table set configurable to define the selected system-level operational functions further comprises a menu tree control table including a menu tree and a plurality of tree nodes invocable by a respective user-triggered event.

18. The computerized system of claim 16 wherein the menu control table is linkable to a search control table configurable to define searchable keys for retrieving information from the database.

19. The computerized system of claim 16 wherein the menu control table is linkable to a data report control table configurable to activate a reporting wizard for generating reports from the database.

20. The computerized system of claim 16 wherein the menu control table is linkable to a menu tree control table including a menu tree and a plurality of tree nodes invocable by a respective user-triggered event.

21. The computerized system of claim 16 wherein the menu control table is linkable to an executable control table configurable to interface with programs external to the customized records management system.

22. The computerized system of claim 15 wherein the second control table set configurable to define the selected input medium for uploading information into the repository database comprises a form control table for gathering input data.

23. The computerized system of claim 22 wherein the form control table is selected from the group consisting of a form display control table, a data tree control table, a dropdown control table, a keypad control table, and a coversheet control table.

24. The computerized system of claim 15 wherein the third control table set configurable to define the selected output medium for downloading information from the repository database comprises a form display control table for displaying output data.

25. The computerized system of claim 15 further comprising a data analysis control table configurable to perform predefined analysis on selected data in the database.

26. The computerized system of claim 19 wherein the user-triggered event comprises a computer-detectable interface event selected from the group consisting of a computer mouse event, a keyboard event, a pointer event, and a user-voice utterance event.

27. The computerized system of claim 15 wherein the customized records system is rebuildable to include any new customization as may be required by the ongoing information needs of the enterprise application based on any new prescribed rules provided by the expert to repopulate the control tables.

28. The computerized system of claim 15 wherein the customized records system is accessible to users and experts via a communications network selected from the group consisting of a local area network, a wide area network, an intranet, and the Internet.
